(19) United States
(12) Patent Application Publication
(10) Pub. No.: US 2025/0149746 A1
(43) Pub. Date: May 8, 2025

(54) BATTERY MODULE AND METHOD FOR MANUFACTURING THE SAME

(71) Applicant: SK On Co., Ltd., Seoul (KR)

(72) Inventors: Jae Hun KIM, Daejeon (KR); Seung Hoon JU, Daejeon (KR)

(21) Appl. No.: 18/937,912

(22) Filed: Nov. 5, 2024

(30) Foreign Application Priority Data
Nov. 6, 2023 (KR) 10-2023-0151620

(51) Int. Cl. H01M 50/505; H01M 50/503; H01M 50/516; H01M 50/533; H01M 50/534

(52) U.S. Cl. CPC H01M 50/505; H01M 50/503; H01M 50/516; H01M 50/533; H01M 50/534

(57) ABSTRACT

The present disclosure relates to a battery module including: a plurality of battery cells, each including an electrode tab; and a bus bar including a plurality of holes into which each of the electrode tabs is inserted and being connected to the electrode tabs to electrically connect the plurality of battery cells to each other, wherein the electrode tabs inserted into the holes and the bus bar are joined to each other by a welding bead, and each of the holes in the direction in which the battery cells are stacked with each other has a width of 0.3 mm to 1.0 mm.

### CROSS-REFERENCE TO RELATED PATENT APPLICATION

The present application claims priority under 35 U.S.C. § 119 (a) to Korean patent application number 10-2023-0151620 filed on Nov. 6, 2023 in the Korean Intellectual Property Office, the entire disclosure of which is incorporated by reference herein.

### BACKGROUND OF THE INVENTION

### 1. Field

The present disclosure relates to a battery module and a method for manufacturing the same.

### 2. Description of the Related Art

Recently, as methods for electrical connection between cells (batteries or secondary batteries) that require a high level of reliability, various methods such as ultrasonic welding, laser welding, and mechanical (bolt/nut) joining have been used. However, laser welding is being used as the most common joining method to respond to the increasing energy density requirements.

In this laser welding method, a method of overlapping single or multiple electrode tabs and bus bars is commonly used. However, this method has limitations such as a large deviation in tensile strength after welding and a high possibility of welding defects such as weak welding depending on the pressurizing conditions. Moreover, the method requires bending and cutting of electrode tabs of multiple specifications within a unit module for welding, thereby increasing the processes and raising the management costs.

In addition, due to the difference in electrode tab length according to the different cell specifications within a module, the resistance of cells is not uniform, which is likely to have a negative impact on the long-term durability. In particular, it was difficult to ensure stable welding quality (tensile strength, electrical resistance, etc.) in welding dissimilar materials such as aluminum (Al) electrode tabs and bus bars.

Moreover, there was also a limitation that the weldable range was limited depending on the volume of the cell tab during welding.

### SUMMARY OF THE INVENTION

According to one aspect of the present disclosure, a problem to solve is to improve the efficiency of a cell manufacturing process.

According to another aspect of the present disclosure, another problem to solve is to provide a battery module which is easier to recycle and a method for manufacturing the same.

Meanwhile, a battery module according to the present disclosure may be widely applied in the field of electric vehicles, battery charging stations, energy storage systems (ESS), and green technology, such solar power generation and wind power generation using batteries. In addition, a battery module according to the present disclosure can be used in eco-friendly mobility including electric vehicles, hybrid vehicles, and others to prevent air pollution and climate change by suppressing greenhouse gas emissions.

A battery module according to the present disclosure may include: a plurality of battery cells, each including an electrode tab; and a bus bar including a plurality of holes into which each of the electrode tabs is inserted and being connected to the electrode tabs to electrically connect the plurality of battery cells to each other. In addition, the electrode tabs inserted into the holes and the bus bar may be joined to each other by a welding bead, and each of the holes in the direction in which the battery cells are stacked with each other may have a width of 0.3 mm to 1.0 mm.

In one embodiment, the width of the holes may be 1.05 to 3.0 times the thickness of the electrode tabs in the direction in which the battery cells are stacked each other.

In one embodiment, the thickness of the electrode tabs may be 0.2 mm or more. In one embodiment, the length of the electrode tabs in the direction in which the electrode tabs protrude from the battery cells may be 0.05 mm to 5.0 mm longer than the thickness of the bus bar in the direction in which the electrode tabs protrude.

In one embodiment, the thickness of the bus bar may be 0.5 mm or more.

In one embodiment, the welding bead may be formed from a separate filler material distinct from the electrode tabs.

In one embodiment, the filler material may include a same material as the electrode tabs.

In one embodiment, the electrode tabs may include one or more of copper or aluminum.

Meanwhile, a battery module according to the present disclosure may include: a plurality of battery cells, each including an electrode tab; and a bus bar including a plurality of holes into which each electrode tab of the plurality of battery cells is inserted and being electrically connected to each of the electrode tabs inserted into each of the plurality of holes; and welding beads formed when welding the electrode tabs and the bus bar along the stacking direction of the plurality of battery cells so as to surround one end of each electrode tab inserted into each of the plurality of holes and protruding outward. In addition, the width of any one hole along the stacking direction of the plurality of battery cells may larger than the thickness of any one electrode tab and smaller than the maximum length of any one welding bead formed on any one of the electrode tabs.

In one embodiment, the welding beads may be formed from at least a part of one of the electrode tabs or a filler material.

A method for manufacturing a battery module according to the present disclosure may include: separating electrode tabs of a plurality of battery cells connected to a first bus bar from the first bus bar; inserting the separated electrode tabs into each of a plurality of holes included in a second bus bar; and joining the electrode tabs to the second bus bar by forming a welding bead. In addition, the width of each of the holes in the direction in which the battery cells are stacked may be 0.3 mm to 1.0 mm.

In one embodiment, the width of the holes may be 1.05 to 3.0 times the thickness of each of the electrode tabs in the direction in which the battery cells are stacked each other.

In one embodiment, the length of the electrode tabs in the direction in which the electrode tabs protrude from the battery cells may be 0.05 mm to 5.0 mm longer than the thickness of the bus bar in the direction in which the electrode tabs protrude.

In one embodiment, in the joining the electrode tabs to the second bus bar, the method for manufacturing the battery module according to the present disclosure may irradiate a laser under the supply of a separate filler material distinct from the electrode tabs.

In one embodiment, the welding bead may be formed using the filler material as a base material.

In one embodiment, the filler material may include a same material as the electrode tabs.

In one embodiment, in the separating the electrode tabs from the first bus bar, the method for manufacturing the battery module according to the present disclosure may cut the electrode tabs.

According to one embodiment of the present disclosure, the efficiency of a cell manufacturing process can be improved.

According to one embodiment of the present disclosure, a battery module which is easier to recycle and a method for manufacturing the same may be provided.

### BRIEF DESCRIPTION OF THE DRAWINGS

FIG. 1 shows a diagram for explaining a battery module according to the present disclosure.

FIG. 2 shows an enlarged diagram of FIG. 1.

FIG. 3 shows a diagram for explaining a bus bar of a battery module according to the present disclosure.

FIG. 4 shows a diagram for explaining a form in which an electrode tab is connected to a bus bar in a battery module according to the present disclosure.

FIG. 5 shows a diagram for explaining a welding bead of a battery module according to the present disclosure.

FIG. 6 shows a flowchart for explaining a method for manufacturing a battery module according to the present disclosure.

FIG. 7 and FIG. 8 show diagrams for explaining Step S100 of FIG. 6.

FIG. 9 shows a diagram for explaining Step S200 of FIG. 6.

FIG. 10 and FIG. 11 show diagrams for explaining Step S300 of FIG. 6.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

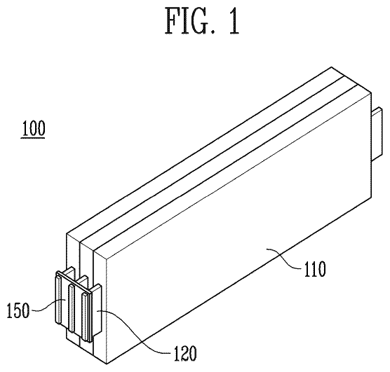

FIG. 1 shows a diagram for explaining a battery module according to the present disclosure.

Referring to FIG. 1, a battery module 100 may include a plurality of battery cells 110 and electrode tabs 120 withdrawn from the battery cells 110. Electrode tabs 120 of each battery cell 110 may be electrically connected by a bus bar 150.

A plurality of battery cells 110 may be stacked each other. Electrode tabs 120 of battery cells 110 may penetrate holes of a bus bar 150.

In an embodiment, each of battery cells 110 may include a cathode, an anode, and a separator disposed therebetween. In an embodiment, a cathode and an anode may each include a current collector and an active material layer disposed on the current collector. For example, a cathode may include a cathode current collector and a cathode active material layer, and an anode may include an anode current collector and an anode active material layer.

Each of battery cells 110 may include one or more electrode tabs 120 protruding in one direction.

In one specific embodiment, a battery cell 110 may be a pouch-type battery cell. A pouch-type battery cell may be a battery cell in which an electrode assembly including a cathode, an anode, and a separator disposed therebetween is sealed in a pouch while being impregnated in an electrolyte (electrolyte solution). A pouch may have a multilayer film structure in which a metal film such as an aluminum film is interposed between an outer layer film and an inner layer film, but is not limited thereto. In a battery module 100 according to one specific embodiment, electrode tabs of each of a plurality of pouch-type battery cells 110 stacked in one direction may inserted and welded into each hole of a bus bar 150, so that the plurality of pouch-type battery cells 110 may be electrically connected to each other.

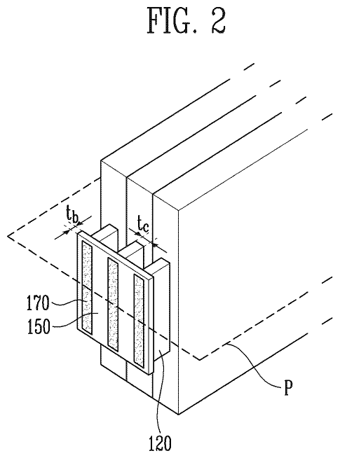

FIG. 2 shows an enlarged diagram of FIG. 1.

Referring to FIG. 2, a welding bead 170 may be formed on a bus bar 150 by welding an electrode tab 120 penetrating a hole formed in the bus bar 150 and the bus bar 150.

In one embodiment, a welding bead 170 may be derived from an electrode tab 120.

In another embodiment, a welding bead 170 may be formed using a separately supplied filler material as a base material during welding.

In one embodiment, a welding bead 170 may be formed using an electrode tab 120 or a filler material as a first base material for welding and a bus bar 150 as a second base material for welding. A welding bead 170 may be derived from 70% to 99% by weight of a first base material and the remainder (1% to 30% by weight) of a second base material, and advantageously, may be derived from 75% to 99% by weight of a first base material and the remainder (1% to 25% by weight) of a second base material. In other words, the dilution rate of a first base material may be 85% to 99% and the dilution rate of a second base material may be 1% to 15%, and advantageously, the dilution rate of a first base material may be 89% to 99% and the dilution rate of a second base material may be 1% to 11%. At this time, a surface plating layer may be formed on an electrode tab, which is a first base material (welding base material), and/or a bus bar 150, which is a second base material. In other words, an electrode tab and/or a bus bar 150 may include a surface plating layer, and in particular, an electrode tab, which must have ensured electric/chemical stability with respect to an electrolyte solution, may include a surface plating layer. As is known, a surface plating layer for ensuring electric/chemical stability with respect to an electrolyte solution may include one of Ni, Sn, Si, Mg, Fe, Mn, Zn, Cr, Li, Ca, or an alloy thereof. When a surface plating layer is present on an electrode tab and/or bus bar 150, the dilution rate of a surface plating layer itself may be calculated through a weight percentage (% by weight) analysis of a welding bead including the above-described first base material, second base material, and plating components. The composition of a weld metal (welding bead) throughout an entire weld may be quantified by energy dispersive spectroscopy (EDS) for various process factors.

In FIG. 2, t_{b} may represent the thickness of a bus bar 150, that is, the thickness of a bus bar 150 in the direction in which an electrode tab 120 protrudes from battery cells. In one embodiment, a bus bar 150 preferably has a thickness of 0.5 mm or more, and may have, for example, a thickness of 0.5 mm to 10 mm, 1 mm to 8 mm, or 1 mm to 6 mm, but is not necessarily limited thereto.

In FIG. 2, t_{c} may represent the thickness of an electrode tab 120, that is, the thickness of an electrode tab 120 in the direction in which the battery cells are stacked each other. An electrode tab 120 may be configured to penetrate a hole in a direction perpendicular to a surface of a bus bar 150. The thickness of an electrode tab 120 may preferably be 0.2 mm or more, and more preferably 0.2 mm to 1.0 mm. When an electrode tab 120 has a thickness of 0.2 mm or more, a welding bead 170 having more preferable properties may be formed.

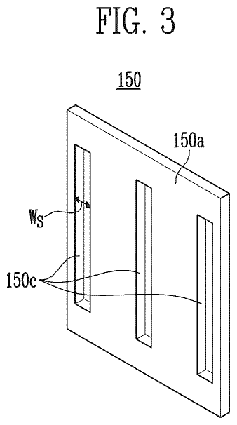

FIG. 3 shows a diagram for explaining a bus bar of a battery module according to the present disclosure.

Referring to FIG. 3, a bus bar 150 may be configured to include a plate 150a and a hole 150c formed in the plate. At this time, the plate may include a plurality of holes 150c capable of accommodating each of a plurality of electrode tabs 120, and each hole 150c may have a shape and size corresponding to a cross-section of an electrode tab so that an end of the electrode tab may be inserted into the hole 150c.

In the present disclosure, one or more holes 150c may be formed in a plate 150a, and electrode tabs inserted into each hole 150c may be welded to electrically connect a plurality of welded battery cells.

In an embodiment, one or more holes 150c may be formed in a plate 150a to correspond to the number of battery cells to be connected. Therefore, in order to electrically connect battery cells, regardless of the number of battery cells to be connected, battery cells may be electrically connected without changing the shape of the battery cells. A plate 150a forming a bus bar 150 may include one or more holes 150c having a preset interval, and a plurality of battery cells may be electrically connected by welding electrode tabs that are inserted into and penetrate through the holes 150c. At this time, since the electrode tabs may be inserted and welded into each hole 150c, a plurality of welded battery cells may be electrically connected through the bus bar 150. In an embodiment, the hole 150c may be formed in a slit shape.

In FIG. 3, wₛ may mean the width of a hole 150c in the direction in which battery cells are stacked each other in a battery module.

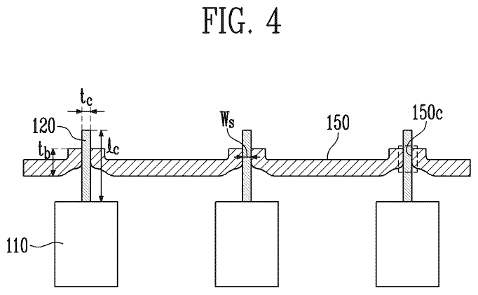

FIG. 4 shows a diagram for explaining a form in which an electrode tab is connected to a bus bar in a battery module according to the present disclosure.

Referring to FIG. 4, an electrode tab 120 of a battery cell (110) may be inserted into a hole 150c formed in a bus bar 150. An electrode tab 120 may be inserted into a hole 150c from one side of a bus bar 150 and may protrude to the other side of the bus bar 150.

In an embodiment, the width (wₛ) of each of holes 150c may be 0.3 mm to 1.0 mm. In one embodiment, the width (wₛ) of holes 150c may be 1.05 to 3.0 times the thickness (t_{c}) of an electrode tab 120, and preferably 1.1 to 2.9 times the thickness (t_{c}) of an electrode tab 120. In other words, by inserting an electrode tab 120 of a battery cell 110 into a hole 150c formed in a bus bar 150 and then welding around the hole 150c to join the electrode tab 120 and the bus bar 150, the electrode tab 120 and the bus bar 150 can be easily joined even when there is a large difference between the width (wₛ) of the hole 150c and the thickness (t_{c}) of the electrode tab 120, and thus the process efficiency can be improved. When an electrode tab and a bus bar 150 joined in another manner, the difference between the width (wₛ) of the hole 150c and the thickness (t_{c}) of the electrode tab 120 must be relatively small in order to align and fix the electrode tabs 120, and in this case, the assembly efficiency of the electrode tab 120 and the bus bar 150 may be reduced.

In one embodiment, when an electrode tab 120 and a bus bar 150 are joined by irradiating a laser to the electrode tab 120, the width (wₛ) of holes 150c may be at most 2.0 times the thickness (t_{c}) of the electrode tab 120. In another embodiment, when an electrode tab 120 and a bus bar 150 are joined by irradiating a laser under the supply of a separate filler material, the width (wₛ) of holes 150c may be at most 3.0 times the thickness (t_{c}) of the electrode tab 120.

In other words, when welding of an electrode tab 120 and a bus bar 150 is performed under the supply of a separate filler material, the electrode tab 120 and the bus bar 150 may be successfully joined even when the width (wₛ) of holes 150c is 2.0 to 3.0 times the thickness (t_{c}) of the electrode tab 120,

In an embodiment, the length (l_{c}) of an electrode tab 120 may be 0.05 mm to 5.0 mm longer than the thickness (t_{b}) of a bus bar 150. The length (l_{c}) of an electrode tab 120 may be, for example, 0.5 mm to 15 mm, 1 mm to 12 mm, or 1 mm to 10 mm. In other words, by inserting an electrode tab 120 of a battery cell 110 into a hole 150c formed in a bus bar 150 and then welding around the hole 150c, the electrode tab 120 and the bus bar 150 can be easily joined even when the difference between the length (l_{c}) of the electrode tab 120 and the thickness (t_{b}) of the bus bar 150 is relatively small or large compared to the conventionally used range, and thus the process efficiency can be improved.

In one embodiment, when an electrode tab 120 and a bus bar 150 are joined by irradiating a laser to the electrode tab 120, the length (l_{c}) of the electrode tab 120 may be 0.5 mm to 2.0 mm longer than the thickness (t_{b}) of the bus bar 150. In another embodiment, when an electrode tab 120 and a bus bar 150 are joined by irradiating a laser under the supply of a separate filler material, the length (l_{c}) of the electrode tab 120 may be 0.05 mm to 3.0 mm longer than the thickness (t_{b}) of the bus bar 150.

In other words, when welding of an electrode tab 120 and a bus bar 150 is performed under the supply of a separate filler material, the electrode tab 120 and the bus bar 150 can be successfully joined even in both cases where the difference between the length (l_{c}) of the electrode tab 120 and the thickness (t_{b}) of the bus bar 150 is relatively small, such as 0.05 mm to 0.5 mm, and where the difference between the length (l_{c}) of the electrode tab 120 and the thickness (t_{b}) of the bus bar 150 is relatively large, such as 2.0 mm to 3.0 mm.

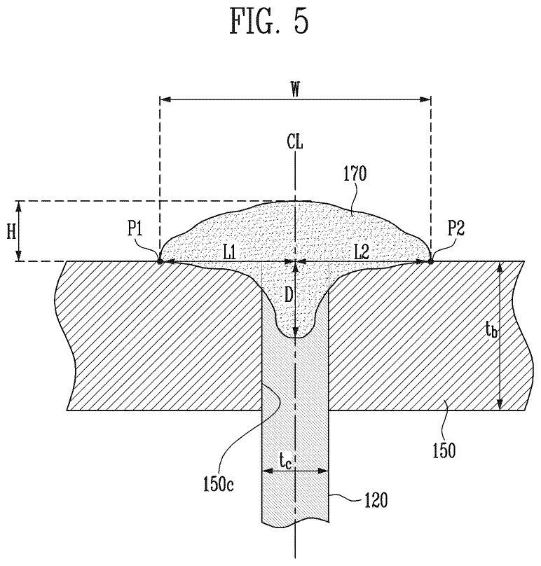

FIG. 5 shows a diagram for explaining a welding bead of a battery module according to the present disclosure.

Referring to FIG. 5, an electrode tab 120 and a bus bar 150 may be joined to each other through a welding bead 170. More specifically, a welding bead 170 can join an electrode tab 120 penetrating a hole 150c to a bus bar 150. In an embodiment, a welding bead 170 may be formed by melting an electrode tab 120 or a filler material by an irradiated laser.

Here, FIG. 5 may represent a cross-section of a welding bead 170 in the thickness (t_{b}) direction of a bus bar 150. Specifically, the cross-section of a welding bead in the thickness (t_{b}) direction of a bus bar 150 may mean a cross-section cut by a virtual plane (a virtual plane having the thickness direction as an in-plane) parallel to the thickness (t_{b}) direction of the bus bar 150, and may mean a weld cross-section that is cut so that the area of the welding bead 170 is minimized. As a practical example, as in the example illustrated in FIG. 2, a virtual plane (p) that creates a cut cross-section of a welding bead 170 may mean a virtual plane that is parallel to the thickness (t_{b}) direction of a bus bar 150 and at the same time, parallel to the thickness (t_{c}) direction of an electrode tab, and the cross-section of a welding bead 170 may mean a cross-section cut by the above-described virtual plane (p).

In an embodiment, a welding bead may have a width (W) and a height (H) satisfying Equations 1 and 2 below.

0<W≤9T <Equation 1>

In Equation 1, W is the width of a welding bead 170 based on the cross-section of the welding bead in the thickness (t_{b}) direction of a bus bar 150, and t_{c} is the thickness of an electrode tab 120.

0<H≤4.5t_{c} <Equation 2>

In Equation 2, H is the height of a welding bead 170 based on the cross-section of the welding bead in the direction of the thickness (t_{b}) of a bus bar 150, and t_{c} is the thickness of an electrode tab 120.

Here, the unit of t_{c} may be millimeter (mm).

In one embodiment, when a welding bead 170 is formed using a separate filler material, the upper limit of the width (W) and height (H) may increase compared to the case where an electrode tab 120 is directly welded.

Advantageously, in order to ensure stable welding quality, the width (W) of a welding bead may be 2t_{c} to 8t_{c}, more advantageously 3t_{c} to 7t_{c}, and the height (H) may be 0.5t_{c} to 3t_{c}, more advantageously 0.5t_{c} to 2t_{c}. When these welding bead 170 width and height are satisfied, excellent welding characteristics can be exhibited with improved tensile strength and low contact resistance. Furthermore, when a welding bead 170 satisfies the width and height, even when specific welding conditions, such as a heat gradient state caused during welding or a laser irradiation method during welding, are changed, a stable and reproducible constant welding quality (improved welding strength, excellent electrical characteristics of the welded area, etc.) may be secured.

The above-described width and height of a welding bead 170 may directly affect the cross-sectional area of the welding bead 170. Accordingly, in another embodiment, an electrode tab 120 and a bus bar 150 inserted into a hole 150c may be joined to each other by a welding bead 170, and the welding bead 170 may satisfy the Equation 3 below.

0<A≤40.5 t_{c}² <Equation 3>

In Equation 3, A is the cross-sectional area of a welding bead 170 based on the cross-section of the welding bead in the thickness (t_{b}) direction of a bus bar 150, and t_{c} is the thickness of an electrode tab.

In one embodiment, when a separate filler material is used to form a welding bead 170, the upper limit of the cross-sectional area A may increase compared to the case where an electrode tab 120 is directly welded.

A welding bead 170 may satisfy the above-described Equations 1 and 2 above while further satisfying Equation 3, and independently of this, may further satisfy Equations 1, 2, or Equations 1 and 2 while further satisfying Equations 3.

The width (W) of a welding bead 170 may mean the distance between two boundary points (p1, p2) on the left and right, when two ends of an electrode tab of the welding bead 170 in the thickness (t_{c}) direction of a bus bar 150 are set to be boundary points (p1, p2) in the cross-section of the welding bead in the thickness (t_{b}) direction of the bus bar 150. At this time, since the example illustrated in FIG. 5 is a case where the two boundary points (p1, p2) on the left and right are positioned at a same height, the width of the bead is illustrated as shown in FIG. 5, and when the two boundary points (p1, p2) on the left and right are not positioned at a same height, the width of the bead may be defined as the shortest distance between the two boundary points. Accordingly, the thickness (t_{c}) direction of an electrode tab may be defined as the width direction of the cross-section of a welding bead 170.

The height (H) of a welding bead 170 may be the distance (shortest distance) between an imaginary line connecting two boundary points (p1, p2) on the left and right and the highest point of the welding bead 170 in the cross-section of the welding bead in the direction of the thickness (t_{b}) of a bus bar 150. At this time, since the example illustrated in FIG. 5 is a case where the two boundary points (p1, p2) on the left and right are positioned at a same height, the width of the bead is only illustrated as shown in FIG. 5, and the height of a welding bead 170 may be defined as the shortest distance between the imaginary line connecting the two boundary points and the highest point of the welding bead 170.

In one specific embodiment, a welding bead 170 may further satisfy Equation 4.

0.4t_{c}≤D≤4t_{c} <Equation 4>

In Equation 4, D is the penetration depth of a welding bead 170 into the hole based on the cross-section of the welding bead 170 in the direction of the thickness (t_{b}) of a bus bar 150, and t_{c} is the thickness of the electrode tab.

In one embodiment, when a welding bead 170 is formed using a separate filler material, the upper limit of the penetration depth (D) may increase compared to the case where an electrode tab 120 is directly welded.

In one specific embodiment, in the cross-section of a welding bead 170 in the direction of the thickness (t_{b}) of a bus bar 150, the welding bead 170 may be symmetrical or asymmetrical with respect to the center line (CL) of a hole 150c. At this time, as an electrode tab 120 is inserted into the hole 150c, the center line of the hole 150c may be the same as the center line of the electrode tab 120 inserted into the hole 150c. Referring to FIG. 5, the left-right asymmetry may mean that when the shortest distances between the two boundary points (p1, p2) on the left and right and the center line of the hole are set to be L1 and L2, and when L1 and L2 are different, the longer length is set to be L2, so that the ratio of L1 and L2 is 1:1 to 1:3.

In one embodiment, when forming a welding bead 170 using a separate filler material, the left-right symmetry of the welding bead 170 may be improved compared to the case where an electrode tab 120 is directly welded.

Referring to FIG. 5, a battery module according to the present disclosure may include: a plurality of battery cells 110 including electrode tabs 120; a plurality of holes 150c into which each electrode tab 120 of the plurality of battery cells 110 is inserted; a bus bar 150 electrically connected to each of the electrode tabs 120 inserted into each of the plurality of holes 150c, and welding beads 170 formed when welding the electrode tabs 120 and the bus bar 150 along a stacking direction of the plurality of battery cells 110 so as to surround one end of each of the electrode tabs 120 inserted into each of the plurality of holes 150c and protruding outward. In addition, along the stacking direction of the plurality of battery cells 110, the width of one hole 150c may be larger than the thickness of one electrode tab 120 and smaller than the maximum length of one welding bead 170 formed on the one electrode tab 120.

In addition, the welding beads 170 may be formed from at least a part of one electrode tab 120 or a filler material.

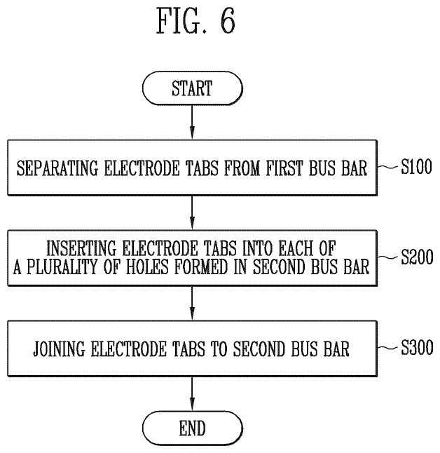

FIG. 6 shows a flowchart for explaining a method for manufacturing a battery module according to the present disclosure.

Referring to FIG. 6, a method for manufacturing a battery module according to the present disclosure may include Step S100 of separating electrode tabs of a plurality of battery cells from a first bus bar. Step S100 may be a process of disassembling a battery module to recycle a previously used battery module. In other words, a first bus bar may be a bus bar included in a previously used battery module. For example, as in one embodiment of the present disclosure, a previously used battery module may be in a form in which electrode tabs of a plurality of battery cells are each inserted into a plurality of holes formed in a bus bar, and then the electrode tabs and the bus bar are joined through a welding bead. Alternatively, a previously used battery module may be in a form in which a plurality of electrode tabs are bent after passing through a single slit formed in a bus bar, and then the bent electrode tabs and the bus bar are bonded.

Next, the method for manufacturing the battery module according to the present disclosure may include Step S200 of inserting each of the electrode tabs into a plurality of holes formed in a second bus bar. Here, the second bus bar may be a bus bar included in a newly assembled battery module. A second bus bar may be a bus bar described in FIGS. 1 to 5.

Next, the method for manufacturing the battery module according to the present disclosure may include Step S300 of joining electrode tabs to the second bus bar. A joint of an electrode tab and a second bus bar may be formed by a welding bead. A welding bead may be formed by melting an electrode tab or a separate filler material. A welding bead may be as described in FIG. 5.

In one embodiment, a method for manufacturing a battery module according to the present disclosure may be a method for recycling and using a previously used battery module. In other words, a battery module manufactured according to a method for manufacturing a battery module according to the present disclosure may be in a form in which battery cells are separated from a previously used battery module and then reassembled on a new bus bar.

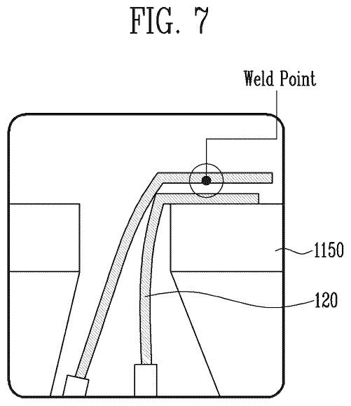

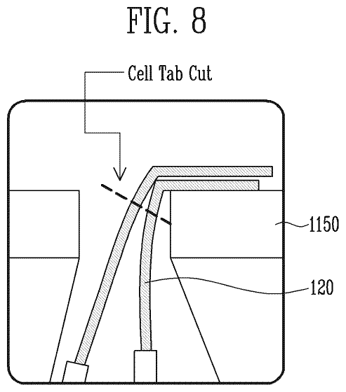

FIG. 7 and FIG. 8 show diagrams for explaining Step S100 of FIG. 6.

Referring to FIG. 7, in one embodiment, a first bus bar 1150 may be a bus bar included in a previously used battery module. In one embodiment, a previously used battery module may be in a form in which a plurality of electrode tabs 120 are bent after passing through a single slit formed in a bus bar, and then the bent electrode tabs 120 and the bus bar 1150 are bonded. Electrode tabs 120 may be bent and positioned on a first bus bar 1150, and welding may be performed at a position on the first bus bar 1150. When electrode tabs 120 and a first bus bar 1150 are joined in this manner, a relatively long length of electrode tabs 120 is required.

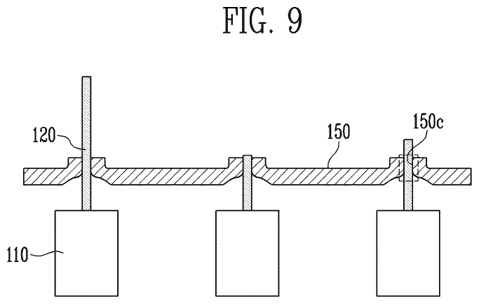

Referring to FIG. 8, electrode tabs 120 connected to a first bus bar 1150 may be separated from the first bus bar 1150. In one embodiment, FIG. 8 may be a process of disassembling a previously used battery module. In an embodiment, the separation of electrode tabs 120 may be performed by cutting the electrode tabs. The cut electrode tabs 120 have a relatively short length, and the lengths of the electrode tabs 120 may not be uniform. Accordingly, when attempting to recycle battery cells in a previously used battery module, recycling may be difficult to some extent due to the constraints of electrode tabs, but a battery module and a manufacturing method thereof according to the present disclosure relate to a new method of resolving these constraints. This will be described in more detail with reference to FIGS. 9 to 11.

FIG. 9 shows a diagram for explaining Step S200 of FIG. 6.

Referring to FIG. 9, an electrode tab 120 of a battery cell 110 may be inserted into a hole 150c formed in a bus bar 150. An electrode tab 120 may be inserted into a hole 150c from one side of a bus bar 150 and protrude to the other side of the bus bar 150.

The lengths of electrode tabs 120 in the protruding direction may not uniform and may be different from each other. Nevertheless, when the lengths of electrode tabs 120 satisfy the range illustrated in FIG. 4, the electrode tabs 120 may be stably connected to a bus bar 150. In other words, when the length of an electrode tab 120 is 0.05 mm to 5.0 mm longer than the thickness of a bus bar 150, the electrode tab 120 and a bus bar 150 can be easily connected, and thus the process efficiency can be improved.

In addition, as described with respect to FIG. 4, the widths of each of holes 150c formed in a bus bar 150 may be 0.3 mm to 1.0 mm, and the widths of the holes 150c may be 1.05 to 3.0 times the thickness (t_{c}) of an electrode tab 120, and preferably 1.1 to 2.9 times the thickness (t_{c}) of an electrode tab 120. In other words, even when there is a large difference between the width of a hole 150c and the thickness of an electrode tab 120, an electrode tab 120 and a bus bar 150 can be easily joined, and thus the process efficiency can be improved.

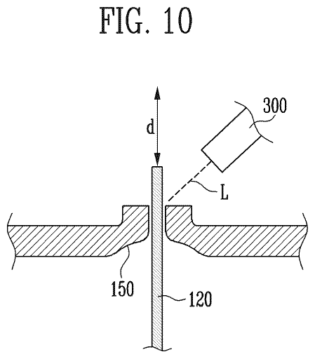

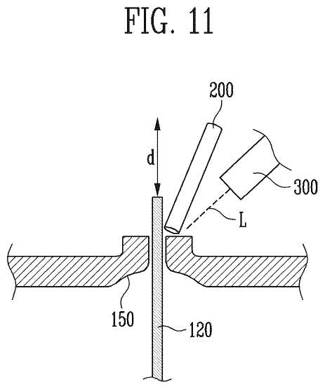

FIG. 10 and FIG. 11 show diagrams for explaining Step S300 of FIG. 6.

Referring to FIGS. 10 and 11, a welding bead may be formed by irradiating a laser to an electrode tab 120 or a separate filler material 200, and the electrode tab 120 and a bus bar 150 may be joined through the welding bead.

FIG. 10 shows an example of irradiating a laser L to an electrode tab 120 through a welding system 300.

A laser L irradiated by a welding system 300 may be irradiated at an angle with respect to the longitudinal direction (d) central axis of an electrode tab 120 inserted into a hole 150c and protruding therefrom. Accordingly, when a laser L is irradiated perpendicularly to an end surface of an electrode tab 120, the possibility that the laser L is directly irradiated to a battery cell and an accident occurs due to an error during welding can be minimized, and also, as the laser L is irradiated obliquely, the welding process of the end surface of the electrode tab 120 can be visually checked, thereby enabling the improvement of the quality and production speed of battery modules.

In the embodiment of FIG. 10, the base material of the formed welding bead may be an electrode tab 120. In other words, an electrode tab 120 may be melted and then cooled to form a welding bead. In one embodiment, a welding bead may be formed using an electrode tab 120 as a first base material and a bus bar 150 as a second base material.

FIG. 11 shows another embodiment in which a laser L is irradiated to a separately supplied filler material 200 through a welding system 300, unlike FIG. 10. A filler material 200 may be disposed on a bus bar 150 or supplied through a separate device. In one embodiment, a filler material 200 may be supplied through a supply portion included in a welding system 300. In one embodiment, a filler material 200 may be supplied in the shape of a wire.

A filler material 200 may be melted by irradiating a laser L to the filler material 200 by a welding system 300. A melted filler material may be cooled again to join an electrode tab 120 and a bus bar 150.

In one embodiment, a filler material 200 may include a same material as an electrode tab 120. When a filler material 200 and an electrode tab 120 are of a same material, a welding bead formed from the filler material 200 and the electrode tab 120 may be easily joined.

In addition, in one embodiment, an electrode tab 120 and a filler material 200 may include materials different from a bus bar 150. For example, an electrode tab 120 may include aluminum (Al), and a bus bar 150 may include copper (Cu). Alternatively, an electrode tab 120 may include copper (Cu), and a bus bar 150 may include aluminum (Al). In another embodiment, an electrode tab 120 and a filler material 200 may include a same material as a bus bar 150.

When a separate filler material 200 is used as in FIG. 11, an electrode tab 120 and a bus bar 150 may be successfully joined even when the width of holes 150c is relatively larger than the thickness of an electrode tab 120.

In addition, when a separate filler material 200 is used as in FIG. 11, an electrode tab 120 and a bus bar 150 may be successfully joined in both cases where the difference between the length of the electrode tab 120 and the thickness of the bus bar 150 is relatively small and where the difference between the length (l_{c}) of the electrode tab 120 and the thickness (t_{b}) of the bus bar 150 is relatively large.

The present disclosure may be implemented in various modified forms, and the scope of the rights is not limited to the above-described embodiments. Therefore, when the modified embodiments include elements of the claims of the present disclosure, they should be considered to fall within the scope of the present disclosure.

What is claimed is:

1. A battery module comprising:
a plurality of battery cells, each including an electrode tab; and
a bus bar including a plurality of holes into which each of the electrode tabs is inserted and being connected to the electrode tabs to electrically connect the plurality of battery cells to each other,
wherein the electrode tabs inserted into the holes and the bus bar are joined to each other by a welding bead, and
each of the holes in the direction in which the battery cells are stacked with each other has a width of 0.3 mm to 1.0 mm.

2. The battery module of claim 1, wherein the width of the holes is 1.05 to 3.0 times the thickness of the electrode tabs in the direction in which the battery cells are stacked each other.

3. The battery module of claim 1, wherein the thickness of the electrode tabs is 0.2 mm or more.

4. The battery module of claim 1, wherein the length of the electrode tabs in the direction in which the electrode tabs protrude from the battery cells is 0.05 mm to 5.0 mm longer than the thickness of the bus bar in the direction in which the electrode tabs protrude.

5. The battery module of claim 4, wherein the thickness of the bus bar is 0.5 mm or more.

6. The battery module of claim 1, wherein the welding bead is formed from a separate filler material distinct from the electrode tabs.

7. The battery module of claim 6, wherein the filler material includes a same material as the electrode tabs.

8. The battery module of claim 1, wherein the electrode tabs include one or more of copper or aluminum.

9. A battery module comprising:
a plurality of battery cells, each including an electrode tab;
a bus bar including a plurality of holes into which each electrode tab of the plurality of battery cells is inserted and being electrically connected to each of the electrode tabs inserted into each of the plurality of holes; and
welding beads formed when welding the electrode tabs and the bus bar along the stacking direction of the plurality of battery cells so as to surround one end of each electrode tab inserted into each of the plurality of holes and protruding outward,
wherein the width of any one hole along the stacking direction of the plurality of battery cells is larger than the thickness of any one electrode tab and smaller than the maximum length of any one welding bead formed on any one of the electrode tabs.

10. The battery module of claim 9, wherein the welding beads are formed from at least a part of one of the electrode tabs or a filler material.

11. A method for manufacturing a battery module, comprising:
separating electrode tabs of a plurality of battery cells connected to a first bus bar from the first bus bar;
inserting the separated electrode tabs into each of a plurality of holes included in a second bus bar; and
joining the electrode tabs to the second bus bar by forming a welding bead,
wherein the width of each of the holes in the direction in which the battery cells are stacked is 0.3 mm to 1.0 mm.

12. The method of claim 11, wherein the width of the holes is 1.05 to 3.0 times the thickness of each of the electrode tabs in the direction in which the battery cells are stacked each other.

13. The method of claim 11, wherein the length of the electrode tabs in the direction in which the electrode tabs protrude from the battery cells is 0.05 mm to 5.0 mm longer than the thickness of the bus bar in the direction in which the electrode tabs protrude.

14. The method of claim 11, wherein the joining the electrode tabs to the second bus bar is performed by irradiating a laser under the supply of a separate filler material distinct from the electrode tabs.

15. The method of claim 14, wherein the welding bead is formed using the filler material as a base material.

16. The method of claim 15, wherein the filler material includes a same material as the electrode tabs.

17. The method of claim 11, wherein the separating the electrode tabs from the first bus bar is performed by cutting the electrode tabs.
